(19) United States
(12) Patent Application Publication
(10) Pub. No.: US 2010/0187809 A1
(43) Pub. Date: Jul. 29, 2010

(54) GAS ADAPTER

(76) Inventor: Nghiep TRUONG, South Pasadena, CA (US)

Correspondence Address: SINORICA, LLC, 2275 Research Blvd., Suite 500, ROCKVILLE, MD, 20850, US

(21) Appl. No.: 12/358,350

(22) Filed: Jan. 23, 2009

(51) Int. Cl. F16L 55/027

(52) U.S. Cl. 285/119

(57) ABSTRACT

A gas adapter on the gas outlet port of a gas canister includes a joint mount connected to the canister, an adapter unit, an elastic part provided between the joint mount and the adapter unit, and a fixture part that fixes the adapter unit to the joint mount. The adapter unit includes a capacity tank. Axially along two ends of the capacity tank, a first adapter tube and a second tube are provided respectively. The first adapter tube passes through into the joint mount and stays near the gas outlet port of gas canister. The second adapter tube passes axially through the joint mount. Thus, a user may fill the lubricant into the capacity tank and use the gas led from the gas canister through the adapter unit to take the lubricant in the capacity tank and then infuse it into loader for simplification of the procedure.

### BACKGROUND OF THE INVENTION

1. Field of the Invention

This invention relates to a gas adapter for airsoft applications.

2. Description of the Prior Art

When filling the gas in a conventional gas gun, lubricant is added for the enhanced effect of lubrication and maintenance. However, in the manner of applying the lubricant, generally, the lubricant is infused into the connector of a gas valve and then, when the gas is filled, the lubricant may or may not enter into a loader together with the gas. Although the lubricant may be filled into the loader in such a manner, the connector must be detached each time lubricant is infused; the issues of more complicated procedure, low convenience, aptness to leakage and waste of lubricant are brought. Thus, improvement is necessarily made.

Consequently, because of the technical defects of described above, the applicant continues to persist tirelessly through vast experience and research to develop the present invention, which can effectively improve the defects described above.

### SUMMARY OF THE INVENTION

A gas adapter according to this invention is affixed on the gas outlet port of a gas canister and mainly comprises a joint mount connected to the canister, an adapter unit, an elastic part provided between the joint mount and the adapter unit, and a fixture part that fixes the adapter unit to the joint mount. The joint mount is provided with a thru hole. The adapter unit is fixed into the thru hole of joint mount and mainly comprises a capacity tank. Axially along two ends of the capacity tank, a first adapter tube and a second tube are provided, respectively. The first adapter tube passes through into the thru hole, stays near the gas outlet port of gas canister, and has a first passage communicating with the capacity tank; further, The second adapter tube axially passes outwards through the thru hole, has a second passage communicating with the capacity tank, and pushes the first adapter tube to touch and drive the gas canister.

Thus, a user may first fill the lubricant into the capacity tank and use the gas led from the gas canister through the first adapter tube to take the lubricant in the capacity tank through the second adapter tube and then infuse it into loader for simplification and completely mixed gas and lubricant of the conventional complicated infusion procedure and enhancement of the performance and convenience of use, and no waste of lubricant.

### BRIEF DESCRIPTION OF THE DRAWINGS

FIG. 1 is a 3D exploded view of a preferred embodiment of this invention;

FIG. 2 is a sectional assembly view of the preferred embodiment of this invention;

FIG. 3 is a sectional view of a gas canister assembled with a loader in the preferred embodiment of this invention;

FIG. 4 is a schematic view illustrating the service state of the gas canister assembled with the loader in the preferred embodiment of this invention;

FIG. 5 is a 3D exploded view of a second preferred embodiment of this invention;

FIG. 6 is a sectional assembly view of the second preferred embodiment of this invention;

FIG. 7 is a 3D view of a fixture part applied in the second preferred embodiment of this invention;

FIG. 8 is a 3D exploded view of a third preferred embodiment of this invention; and

FIG. 9 is a sectional assembly view of the third preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

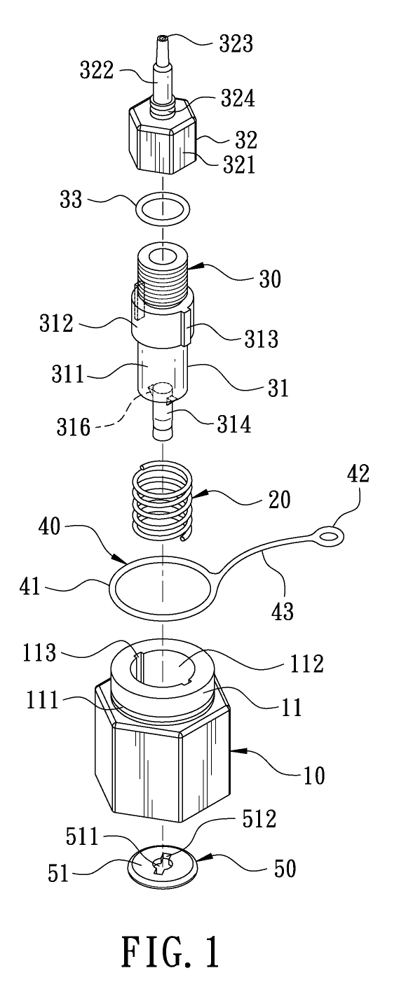

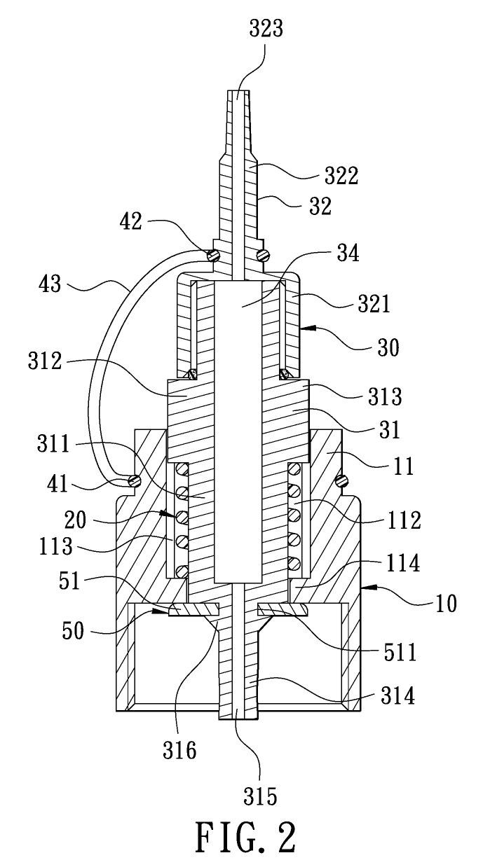

Firstly, with reference to FIGS. 1 and 2 shown respectively as a 3D exploded view and a sectional assembly view of a preferred embodiment of this invention, a gas adapter mainly comprises a joint mount 10, an elastic part 20, an adapter unit 30, a fastening ring unit 40, and a fixture part 50.

The joint mount 10 that is a polygonal cap the top side of which is formed with a pivot sheath 11. An annular 111 is formed around the circumference of pivot sheath 11, and a round thru hole 112 is defined in the middle of pivot sheath 11. Two rectangular guidance grooves 113 opposite to each other are formed axially from outside to inside on the inner circumferential wall of thru hole 112; a shift limit ring 114 is inwards provided in radial around the bottom of thru hole 112. In a preferred embodiment of this invention, the joint mount 10 is fully molded and made of plastics.

The elastic part 20 is provided in the thru hole 112 of pivot sheath 11 and abuts against the top side of shift limit ring 114. In the preferred embodiment of this invention, the elastic part 20 is a compression spring.

The adapter unit 30 passes through into the thru hole 112 of pivot sheath 11, abuts against the elastic part 20, comprises a first adapter 31 and a second adapter 32 connected to the first adapter 31.

The first adapter 31 comprises a first joint portion 311. A flange 312 is provided in radial around the middle section of outer circumferential wall of the first joint portion 311. A shift limit lug 313 opposite to the guidance groove 113 is provided on the outer circumferential wall of the flange 312. The shift limit lug 313 is approximately formed into a rectangular rib. Further, a first adapter tube 314 is provided outside an axial end of the first joint portion 311, and a first passage 315 is formed inside the first adapter tube 314. Two approximately triangular wedge lugs 316 opposite to each other are formed on the outer circumferential wall of the first adapter tube 314.

The second adapter 32 comprises a second joint portion 321. A second adapter tube 322 is provided stretching outwards at an axial end of the second joint portion 321, and a second passage 323 is formed inside the second adapter tube 322. Besides, an annular groove 32 is formed on the outer circumferential wall of second adapter tube 322. The second joint portion 321 joins the first joint portion 311, between which an O-shaped ring 33 is provided for achievement of preferred airtight capability. A capacity tank 34 is defined between the first joint portion 311 and the second joint portion 321. In the preferred embodiment of this invention, the first adapter tube 314 communicates with the capacity tank 34 and the second adapter tube 322. The adapter unit 30 is fully molded and made of plastics.

The fastening ring group 40 comprises a first fastening ring 41 and a second fastening ring 42 that are connected to each other, and the first fastening ring 41 is arranged around in the annular groove 111 of the joint mount 10 and the second fastening ring 42 is arranged around in the annular groove 324 of the second adapter 32, respectively. A tie line 43 is provided between the first fastening ring 41 and the second fastening ring 42 to prevent the second adapter 32, when being removed, from loosing and falling. In the preferred embodiment of this invention, the fastening ring group 40 is flexible.

The fixture part 50 comprises a round retainer clamp 51. The retainer clamp 51 wedges between the first joint portion 311 and the wedge lug 316 and abuts against the bottom side of shift limit ring 114 of the joint mount 10. A thru hole 511 is formed in the middle of retainer clamp 51. Two thru holes 512 opposite to each other are formed in radial and stretch outwards from the thru hole 511.

With reference to FIGS. 1 and 2, the elastic part 20 is provided in the thru hole 112 of pivot sheath 11. The first adapter 31 and the second adapter 32 join together, and the shift limit lug 313 of first adapter 31 is used to pass through into the thru hole 112 along the guidance groove 113 of the pivot sheath 11. An effect of shift limit is caused between the guidance groove 113 and the shift limit lug 313. Further, The flange 312 of first adapter 31 abuts against the elastic part 20 for generation of upward elastic support. The first adapter tube 314 of first adapter 31 passes through the shift limit ring 114 of the joint mount 10 and through the first adapter tube 314 via the thru hole 511 of retainer clamp 51, further making the rectangular thru hole 512 pass through the wedge lug 316. Besides, it is turned at an angle to fix the wedge lug 316 to the bottom of retainer clamp 51, which is in an initial state.

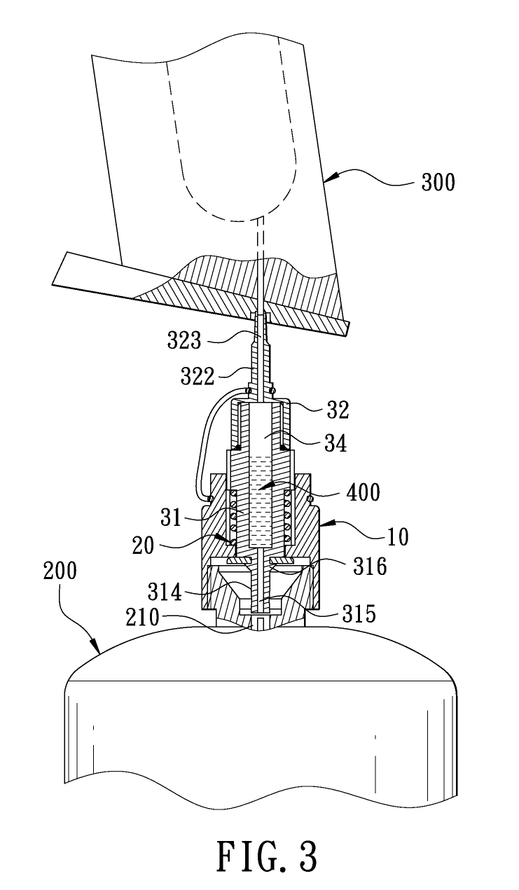

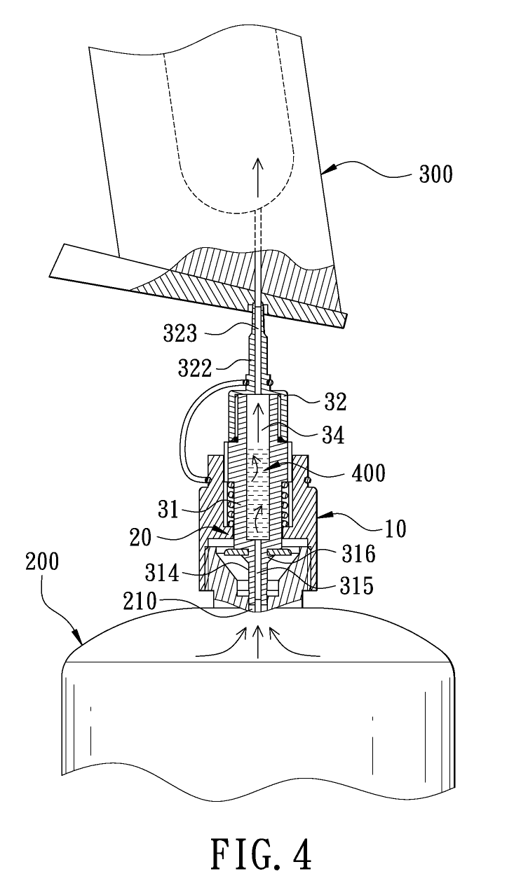

With reference to FIGS. 3 and 4, the joint mount 10 is connected to a gas canister 200. The gas canister 200 is provided with a gas outlet port 210. The first adapter tube 314 is opposite to the gas outlet port 210. The second adapter tube 322 at the other end of the first adapter tube 314 is connected to a loader 300. When it is used, a lubricant 400 is infused into only the capacity tank 34 between the first adapter 31 and the second adapter 32 to make the loader 300 push down the second adapter tube 322 and indirectly drive the first adapter tube 314 to move downwards and further connect to connect to the gas outlet port 210 of gas canister 200 so that the gas in the gas canister 200 may be infused into the loader 300 from the gas outlet port 210 through the first passage 315, the capacity tank 34, and the second passage 323; when the gas in the gas canister 200 is infused into the loader 300, the lubricant 400 in the capacity tank 34 may be led into the loader 300 at the same time. When the gas filling is finished and no pressure is applied to the second adapter 32, the elastic part 20 upwards abut against the first adapter 31 and the initial state returns.

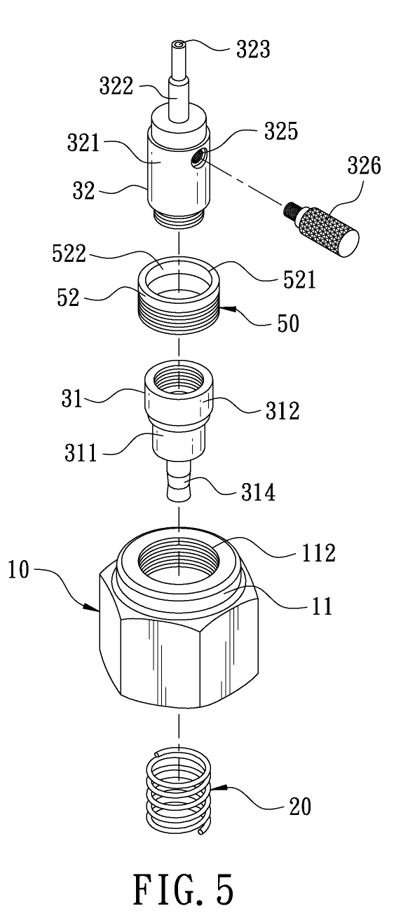

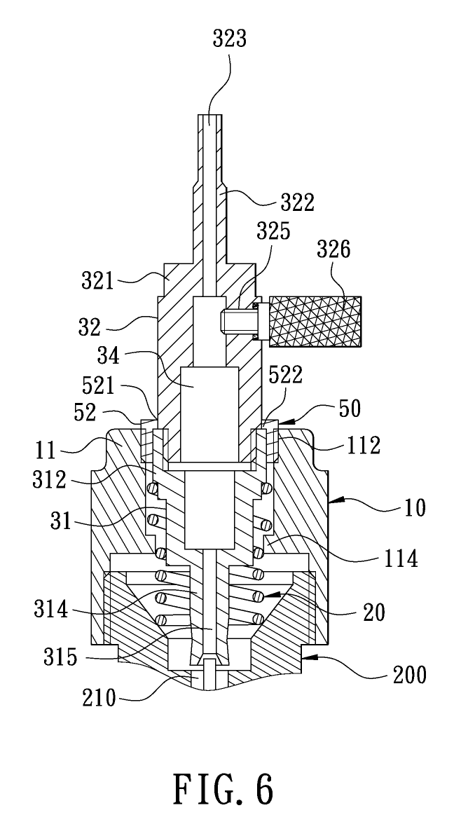

Refer to FIGS. 5 and 6 shown respectively as a 3D exploded view and a sectional assembly view of a second preferred embodiment of this invention. The major structure and effect in the embodiment is the same as that in the previous preferred embodiment, so unnecessary details are not given here. What is significantly different is one end of the elastic part 20 is wedge into the thru hole 112 of the pivot sheath 11, and the other end that axially stretches downwards to the top fringe of gas canister 200. The first adapter 31 is connected to the second adapter 32 and passes through into the thru hole 112 of the pivot sheath 11. The flange 312 of first adapter 31 abuts against the elastic part 20. The adapter tube 314 passes through the shift limit ring 114 and stays opposite to the gas outlet port 210 of gas canister 200. Further, an oil outlet 325 communicating with the capacity tank 34 is formed on the outer circumferential wall of second joint portion 321 to infuse the lubricant 400 into the capacity tank 34, and the oil outlet 325 is spirally formed with a spiral connection rod 326. Further, the fixture part 50 is provided in the thru hole 112 of the pivot sheath 11. The fixture part 50 comprises a fixture tube 52. The fixture tube 52 has a thru hole 521 communicating with the thru hole 112 and passes through outside the second adapter 32. An annular wedge fringe 522 is inwards formed in radial on the inner wall of the top side of thru hole 521. The wedge fringe 522 is wedged to the top side of flange 312 of the first adapter 31.

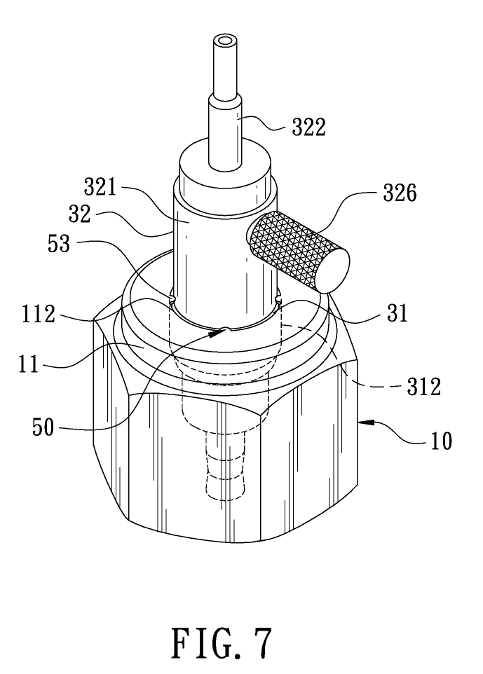

Refer to FIG. 7 as a 3D view of the other fixture part applied in a second preferred embodiment of this invention. The major structure and effect in the embodiment is the same as that in the second preferred embodiment, so unnecessary details are not given here. What is significantly different is the fact that the fixture part 50 comprises a plurality of stoppers 53 structured with four stop points, provided at the top fringe of thru hole 112 of the pivot sheath 11, and wedged to the top side of flange 312 of the first adapter 31.

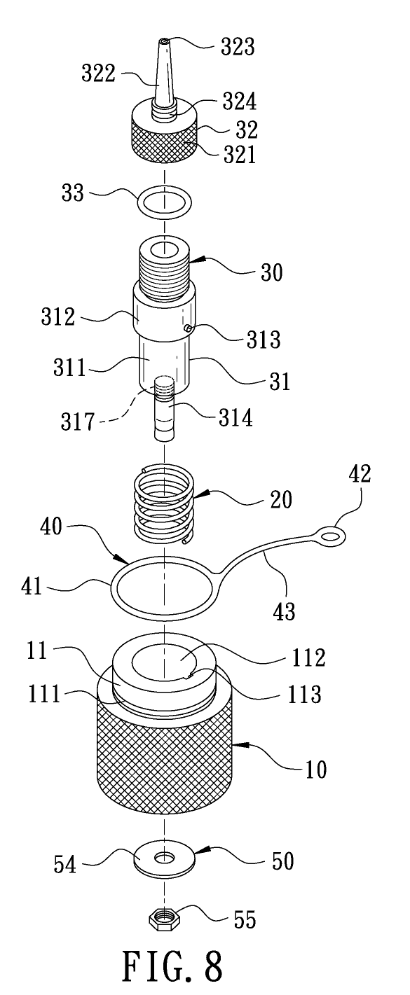

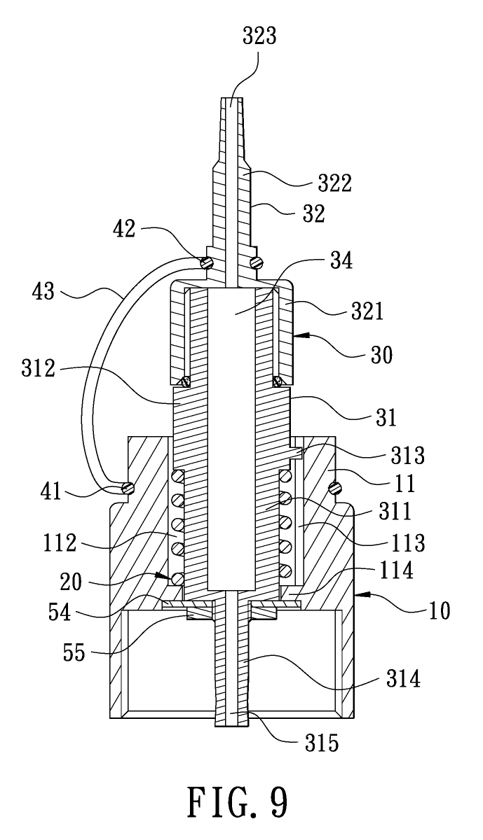

Refer to FIGS. 8 and 9 shown respectively as a 3D exploded view and a sectional assembly view of a third preferred embodiment of this invention. The major structure and effect in the embodiment is the same as that in the previous preferred embodiment, so unnecessary details are not given here. What is significantly different is the fact that a guidance groove 113 is formed axially on the inner circumferential wall of thru hole 112 of the pivot sheath 11, the shift limit lug 313 opposite to the guidance groove 113 is provided on the flange 312 of the first adapter 31 and in the form of a round cylinder, and the shift limit lug 313 of first adapter 31 is used to pass through into the thru hole 112 along the guidance groove 113 of the pivot sheath 11 and cause an effect of transversal shift limit; further, outer threads 317 are formed on the outer circumferential wall of the first adapter tube 314; the fixture part 50 is spirally set around and fixed to the first adapter tube 314, and comprises a cushion 54 and a screw nut 55, in which the cushion 54 passes through and spirally fixes the first adapter tube 314 through the outer threads 317 of the screw nut 55 and first adapter tube 314 to firmly stays between the bottom of shift limit ring 114 and the screw nut 55.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A gas adapter, being provided on the gas outlet port of a gas canister and mainly comprising:
a joint mount that is in the form of a cap and connects to the gas canister, the middle section of which is axially formed a thru hole;
an adapter unit being fixed into the thru hole of the joint mount and mainly comprising a capacity tank, in which axially along two ends of the capacity tank, a first adapter tube and a second adapter tube are provided, respectively, the first adapter tube passes through into the thru hole, stays near the gas outlet port of gas canister, and has a first passage communicating with the capacity tank, and the second adapter tube axially passes outwards through the thru hole and has a second passage communicating with the capacity tank;
an elastic part provided between the joint mount and the adapter unit; and
a fixture part that connects and fixes the adapter unit to the joint mount.

2. The gas adapter according to claim 1, wherein a first adapter is axially provided with a first joint portion to form a first adapter, the second adapter tube is also axially provided with a second joint portion to form a second adapter, the first adapter is connected to the second adapter to form the adapter unit, between which the capacity tank is defined.

3. The gas adapter according to claim 2, wherein the fixture part is a fixture tube that is spirally connected to the thru hole of the joint mount and has a perforation hole communicating with the thru hole of the joint mount, an annular wedge fringe is formed in radial on the inner circumferential wall of the top side of perforation hole, and the wedge fringe is fixed to a determined site of the adapter unit.

4. The gas adapter according to claim 2, wherein the fixture part comprises a plurality of stoppers that are provided at the top fringe of thru hole of the joint mount and fixed to the determined site of adapter unit.

5. The gas adapter according to claim 2, wherein the fixture part is a round retainer clamp, two wedge lugs opposite to each other are formed on the outer circumferential wall of the first adapter tube, the retainer clamp wedges between the wedge lugs and the bottom fringe of the thru hole of the joint mount to make the adapter unit to be fixed into the joint mount.

6. The gas adapter according to claim 2, wherein the fixture part further comprises a cushion and a screw nut, outer threads are formed on the outer circumferential wall of the adapter unit, the cushion passes through the first adapter tube, and the screw nut is spirally arranged around the outer threads of first adapter tube to make the cushion to be fixed between the wedge lugs and the bottom fringe of thru hole of the joint mount and thus the adapter unit to be fixed into the joint mount.

7. The gas adapter according to claim 1, wherein at least one shift limit lug is provided in radial on the outer circumferential wall of the adapter unit, a guidance groove opposite to the shift limit lug is formed through in radial on the inner circumferential wall of thru hole of the joint mount, and a shift limit ring is inwards formed in radial at the bottom of guidance groove.

8. The gas adapter according to claim 1, wherein a gas filling port communicating with the capacity tank is further provided on the outer circumferential wall of the adapter unit and spirally connected to a spiral connection rod.

9. The gas adapter according to claim 2, wherein a first fastening ring and a second fastening ring are set respectively around the joint mount and the second adapter tube and a tie line is provided between the first fastening ring and the second fastening ring.

10. The gas adapter according to claim 2, wherein an O-shaped ring is provided between the first adapter and the second adapter.
